(19) United States
(12) Patent Application Publication
(10) Pub. No.: US 2026/0066597 A1
(43) Pub. Date: Mar. 5, 2026

(54) CONNECTOR CIRCUIT BOARD AND POSITIONING CONNECTOR ADAPTOR THEREOF

(71) Applicant: F TIME TECHNOLOGY INDUSTRIAL CO., LTD., New Taipei City (TW)

(72) Inventors: Chien-Chang HUANG, New Taipei City (TW); Chang-Lin PENG, New Taipei City (TW)

(73) Assignee: F TIME TECHNOLOGY INDUSTRIAL CO., LTD., New Taipei City (TW)

(21) Appl. No.: 18/822,676

(22) Filed: Sep. 3, 2024

(51) Int. Cl. H01R 24/50; H01R 12/70; H01R 12/71; H01R 24/54

(52) U.S. Cl. CPC H01R 24/50; H01R 12/7047; H01R 12/712; H01R 24/542

(57) ABSTRACT

A connector circuit board has multiple positioning connector adaptors, a circuit board and multiple fixing parts. The positioning connector adaptor has a casing, an insulator, a center pin and a board. The insulator is mounted in the casing. The center pin is mounted through the insulator. One side of the board is connected to one end of the casing, and the center pin is mounted through the board. The board has two through-holes and two locating columns. The two through-holes penetrate through the board. The two locating columns are mounted on one side of the board, and the two locating columns protrude away from the casing. The circuit board is connected to the positioning connector adaptors and comprises multiple apertures. Each of the locating columns is mounted through one of the apertures. The fixing parts are mounted through each of the through-holes.

### BACKGROUND OF THE INVENTION

### 1. Field of the Invention The present invention relates to a connector circuit board and a positioning connector adaptor thereof.

### 2. Description of the Prior Arts

With the flourishing of the communications industry, electronic products continue to strive for better transmission quality and timeliness, as well as offering diverse applications. A conventional connector adaptor is configured to connect a circuit board and comprises a board connector. The board connector comprises a connecting section and a board. The connecting section comprises a casing, an insulator and a center pin. The insulator is mounted through the casing, and the center pin is connected to the circuit board and is mounted through the insulator. The board is connected to one end of the casing, and the center pin is mounted through the board. The board comprises two through-holes located on opposite sides of the center pin for fastening the board to the circuit board with screws.

Since the connector is used for high-frequency connection, the contact area of the center pin and the circuit board is small. When the board is fastened to the circuit board, the force applied to both sides of the board may be uneven, which will cause the center pin to deviate from the conductive contact range of the board, resulting in poor contact between the connector and the circuit board. In order to minimize the center pin deflection, the position of the center pin has to be checked repeatedly during fastening, resulting in slow assembly.

To overcome the shortcomings, the present invention provides a connector circuit board and positioning connector adaptor thereof to mitigate or obviate the aforementioned problems.

### SUMMARY OF THE INVENTION

The main objective of the present invention is to provide a connector circuit board and a positioning connector adaptor thereof that solves the problem caused by the uneven forces on both sides of the board when fastening the connector to the circuit board. The uneven forces lead the center pin to deviate from the conductive contact range of the circuit board and slow down the assembly speed.

The connector circuit board has multiple positioning connector adaptors, a circuit board, and multiple fixing parts. A positioning connector adaptor includes a casing, an insulator, a center pin, and a board.

The insulator is mounted in the casing. The center pin is mounted through the insulator. One side of the board is connected to one end of the casing, the center pin is mounted through the board, and the board comprises two through-holes and two locating columns.

The two through-holes penetrate through the board and are located parallel to each side of the center pin. The two locating columns are mounted on one side of the board, the two locating columns and the casing are opposite each other, the two locating columns are located parallel to each side of the center pin and protrude away from the casing.

The circuit board is connected to the positioning connector adaptor and comprises multiple apertures and multiple conductive layers. Each of the through-holes corresponds to one of the apertures in position. Each of the locating columns is mounted through one of the apertures. The conductive layers are mounted on one surface of the circuit board, and the center pin of each one of the positioning connector adaptors is connected to one of the conductive layers. The fixing parts are mounted through each of the through-holes.

The advantage of this invention is to add the locating columns, so that the board can be quickly positioned on the circuit board during assembly. Meanwhile, the center pin can be located in the correct position, without having to pay special attention to whether the positioning of the center pin of the positioning connector adaptor is aligned within the conductive layers at the center of the circuit board. In addition, since the locating column is mounted through the aperture, the center pin will not deviate from the correct position due to the uneven force during the fastening process.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a connector circuit board in accordance with the present invention;

FIG. 2 is an exploded view of the connector circuit board in FIG. 1;

FIG. 3 is a sectional view of the connector circuit board in FIG. 1;

FIG. 4 is a perspective view of a positioning connector adaptor in accordance with a first embodiment of the present invention;

FIG. 5 is a perspective view of the positioning connector adaptor in FIG. 4;

FIG. 6 is a sectional view of the positioning connector adaptor in FIG. 4;

FIG. 7 is a perspective view of a positioning connector adaptor in accordance with a second embodiment of the present invention;

FIG. 8 is an exploded view of the positioning connector adaptor in FIG. 7;

FIG. 9 is a perspective view of a positioning connector adaptor in accordance with a third embodiment of the present invention;

FIG. 10 is an exploded view of the positioning connector adaptor in FIG. 9;

FIG. 11 is a perspective view of a positioning connector adaptor in accordance with a fourth embodiment of the present invention; and

FIG. 12 is an exploded view of the positioning connector adaptor in FIG. 11.

### DETAILED DESCRIPTION OF THE PREFERRED EMBODIMENTS

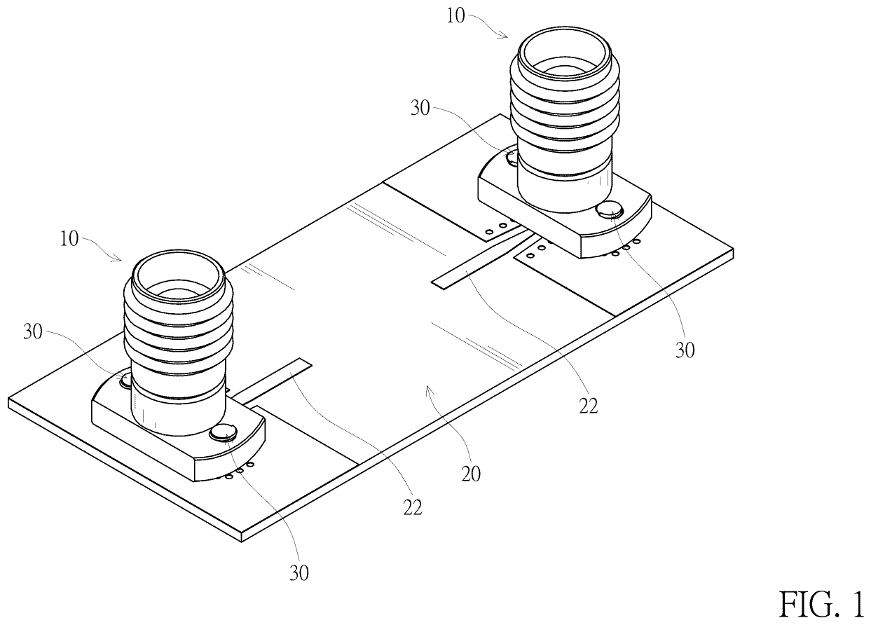

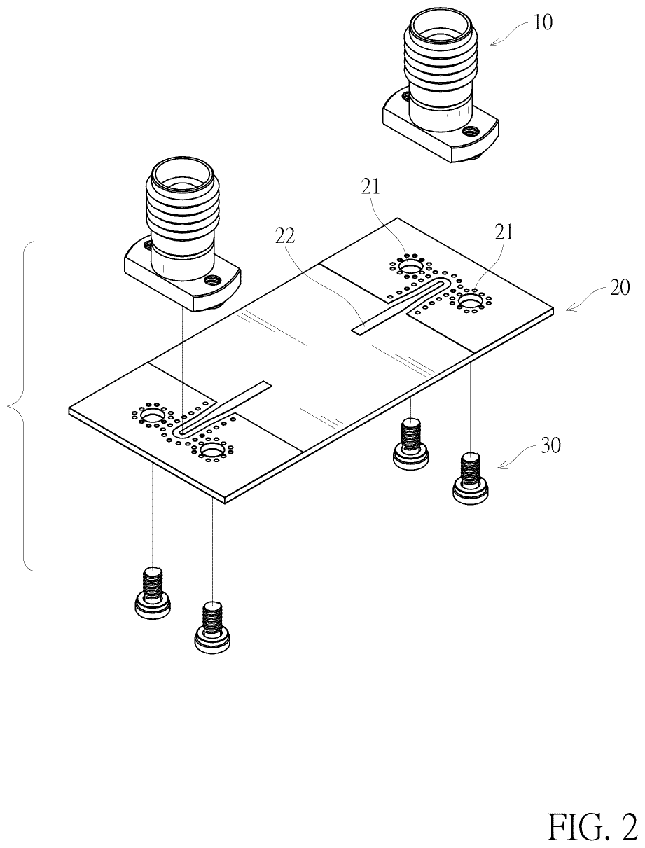

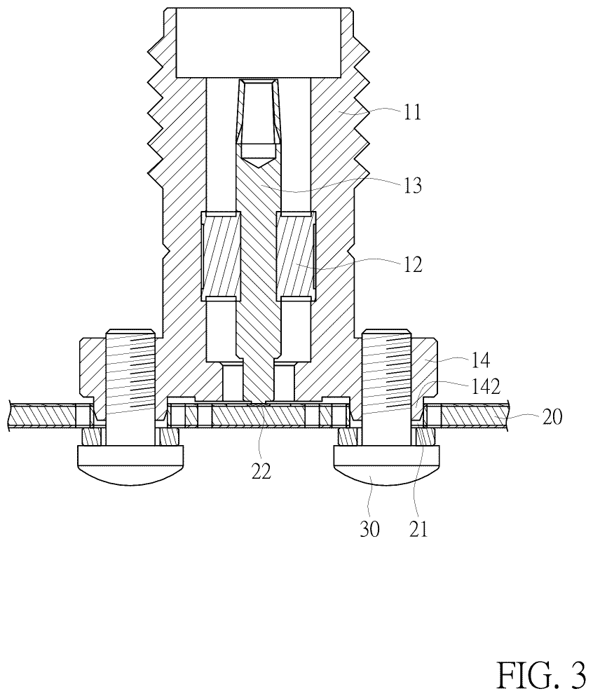

With reference to FIG. 1 to FIG. 3, a connector circuit board 20 in accordance with the present invention comprises multiple positioning connector adaptors 10, a circuit board 20 and multiple fixing parts 30.

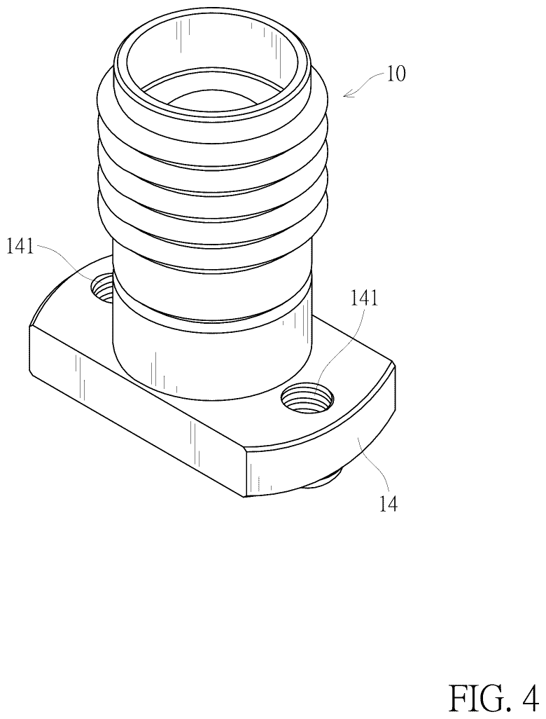

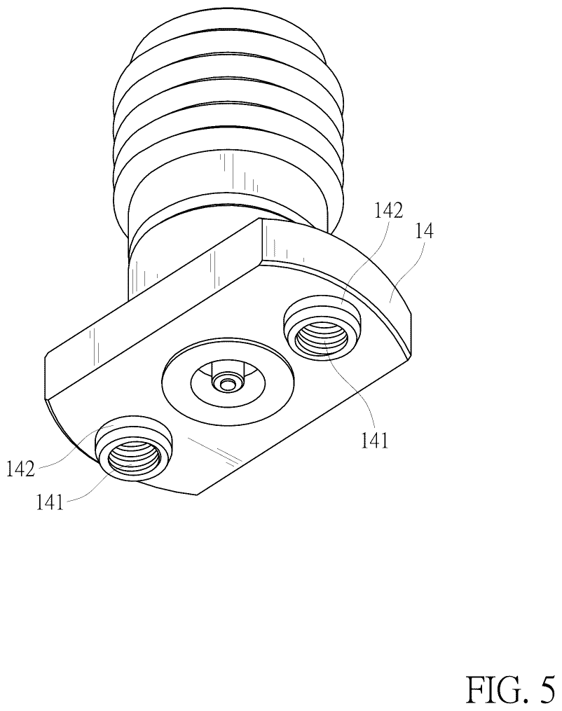

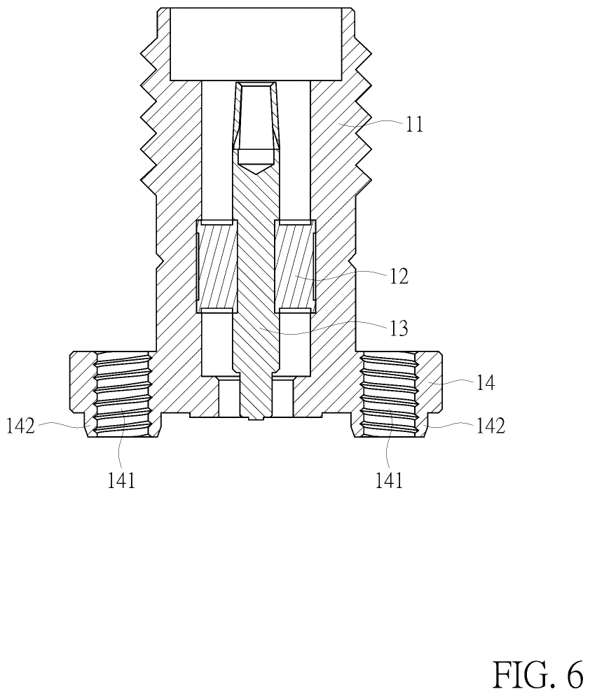

With reference to FIG. 4 to FIG. 6, the positioning connector adaptor 10 includes a casing 11, an insulator 12, a center pin 13 and a board 14. The insulator 12 is mounted in the casing 11, and the center pin 13 is mounted through the insulator 12. One side of the board 14 is connected to one end of the casing 11, and the center pin 13 is mounted through the board 14.

The board 14 comprises two through-holes 141 and two locating columns 142. The two through-holes 141 penetrate through the board 14. The two through-holes 141 are respectively located on two opposite sides of the center pin 13 and extend parallel with the center pin 13. The locating columns 142 are mounted on one side of the board 14, the two locating columns are mounted on a surface of the board 14, and the surface of the board 14 is opposite to the casing 11. The two locating columns 142 are respectively located on the two opposite sides of the center pin 13 and protrude away from the casing 11.

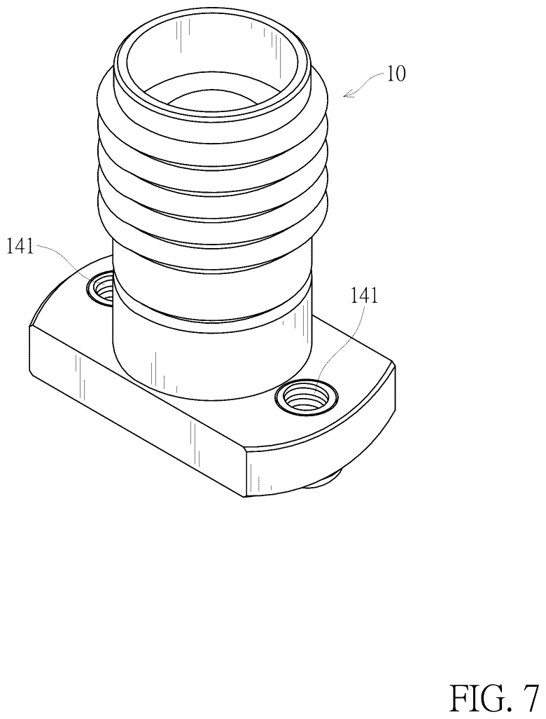

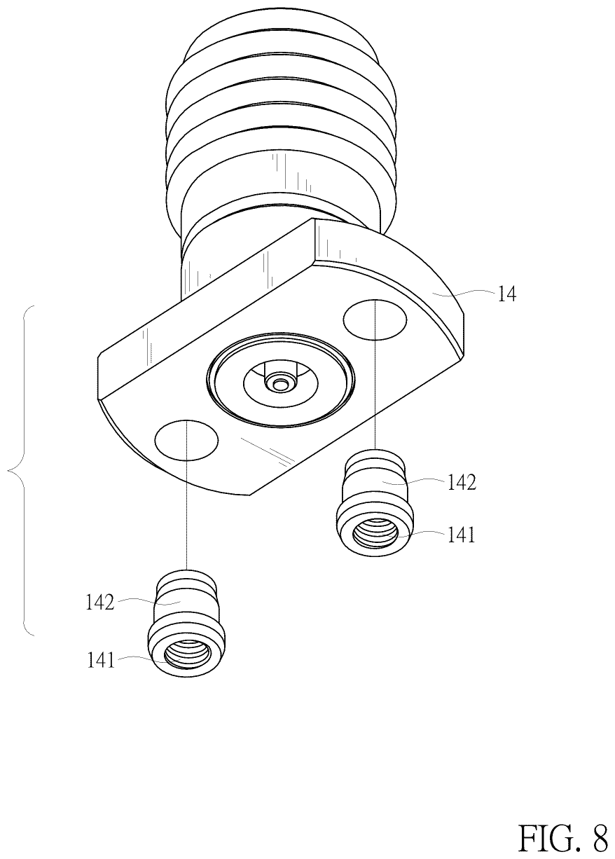

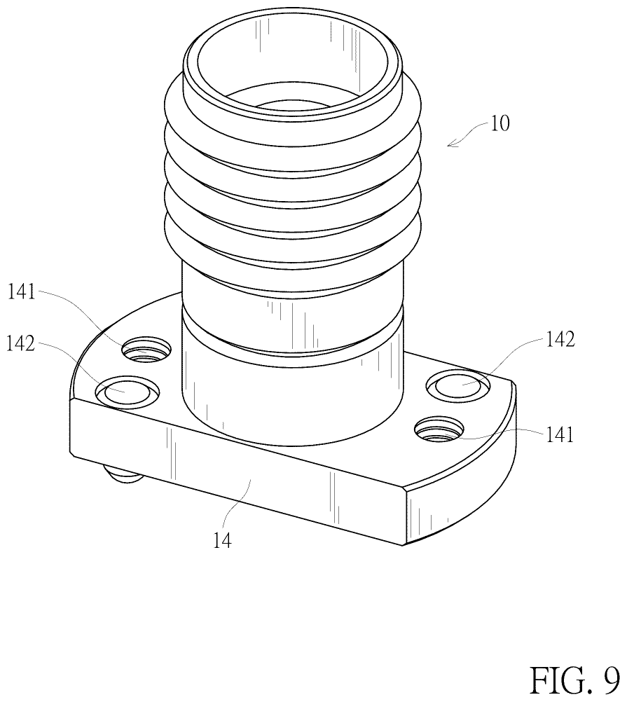

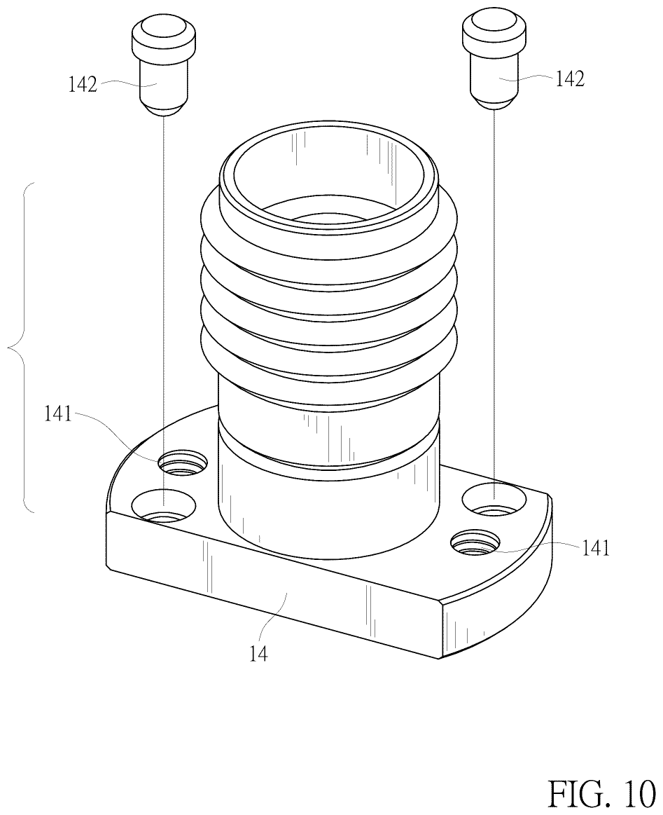

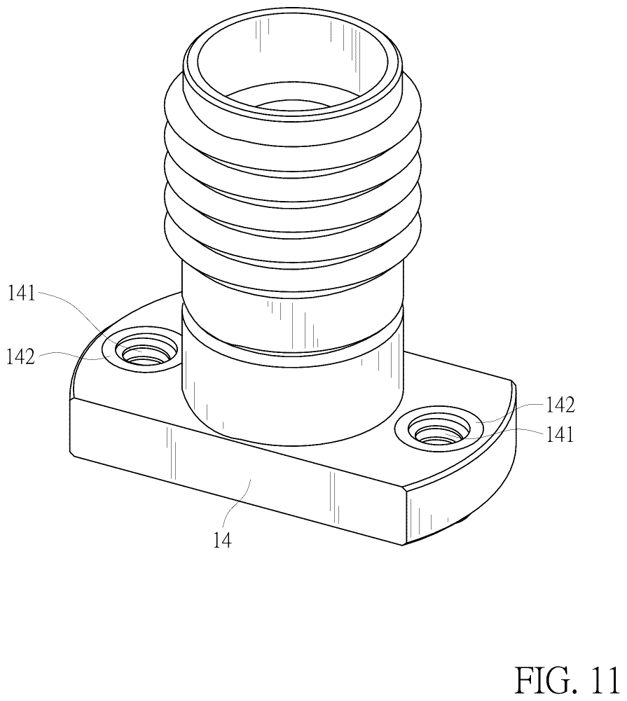

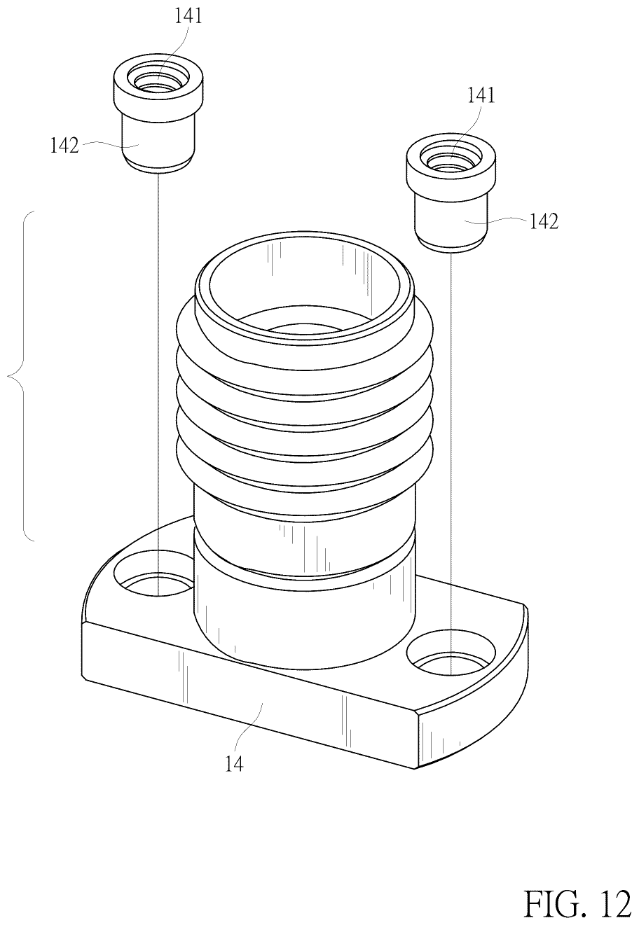

With reference to FIG. 4 to FIG. 6, in the first embodiment, the two locating columns 142 and the board 14 are formed in one piece. Each one of the through-holes 141 is on a same axis as one of the locating columns 142 and is capable of penetrating through the locating columns 142. With reference to FIG. 7 and FIG. 8, in the second embodiment, the two locating columns 142 are detachably mounted through the board 14. Each one of the through-holes 141 is on a same axis as one of the locating columns 142 and is capable of penetrating through the locating columns 142. With reference to FIG. 9 and FIG. 10, in the third embodiment, the two locating columns 142 are detachably mounted through the board 14. Each one of the through-holes 141 is on different axes as one of the locating columns 142. In another embodiment, the two locating columns 142 and the board 14 are formed in one piece. With reference to FIG. 11 and FIG. 12, in the fourth embodiment, the two locating columns 142 are detachably mounted through the board 14. Each one of the through-holes 141 is on a same axis as one of the locating columns 142 and is capable of penetrating through the locating columns 142.

In this embodiment, each one of locating columns 14 corresponds to a respective one of the through-holes 141 in shape, and each one of the locating columns 142 and the respective one of the through-holes 141 are located coaxially. In other words, the through-holes 141 penetrate through the locating columns 142. In another embodiment, the position of the locating columns 142 in relation to the through-holes 141 is not limited, and the locating columns 142 and the through-holes 141 may also be located on different axes.

The circuit board 20 is connected to the positioning connector adaptor 10 and comprises multiple apertures 21 and multiple conductive layers 22. Each of the through-holes 141 corresponds to the respective one of the apertures 21 in position, and each of the locating columns 142 is mounted through the respective one of the apertures 21. The fixing parts 30 are mounted through each of through-hole 141. The conductive layers 22 are mounted on one surface of the circuit board 20, and the center pin 13 of each one of the positioning connector adaptors 10 connected to one of the conductive layers 22.

In the first to fourth embodiments, when the positioning connector adaptor 10 is set on the circuit board 20, each of the locating columns 142 is first placed into the corresponding aperture 21 for positioning, and the center pin 13 of the positioning connector adaptor 10 is connected to one of the conductive layers 22 of the circuit board 20. Then the fixing parts 30 are mounted through both the through-holes 141 and the apertures 21, thereby fixing the positioning connector adaptor 10 to the circuit board 20.

The advantage of this invention is to add the locating columns 142, so that the board 14 can be quickly positioned on the circuit board 20 during assembly. Meanwhile, the center pin 13 can be located in the correct position, without having to pay special attention to whether the positioning of the center pin 13 of the positioning connector adaptor 10 is aligned within the conductive layers 22 at the center of the circuit board 20. In addition, with the locating column 142 mounted through the aperture 21, the center pin 13 will not deviate from the correct position due to the uneven force during the fastening process.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A positioning connector adaptor comprising:
a casing;
an insulator mounted in the casing;
a center pin mounted through the insulator;
a board, one side of the board connected to one end of the casing, the center pin mounted through the board, and the board comprising:
two through-holes penetrating through the board, respectively located on two opposite sides of the center pin, and extending parallel with the center pin;
two locating columns on a surface of the board, the surface of the board being opposite to the casing, the two locating columns respectively located on two sides of the center pin and protruding away from the casing.

2. The positioning connector adaptor as claimed in claim 1, wherein, each one of the through-holes penetrates through one of the locating columns.

3. The positioning connector adaptor as claimed in claim 1, wherein, the two locating columns are detachably mounted through the board.

4. The positioning connector adaptor as claimed in claim 2, wherein, the two locating columns are detachably mounted through the board.

5. A connector circuit board comprising:
multiple positioning connector adaptors as claimed in claim 1;
a circuit board connected to the positioning connector adaptors and comprising:
multiple apertures, each of the through-holes corresponding to a respective one of the apertures in position; each of the locating columns mounted through one of the apertures;
multiple conductive layers mounted on one surface of the circuit board, and the center pin of each one of the positioning connector adaptors connected to one of the conductive layers;
multiple fixing parts mounted through each of the through-holes.

6. A connector circuit board comprising:
multiple positioning connector adaptors as claimed in claim 4;
a circuit board connected to the positioning connector adaptors and comprising:
multiple apertures, each of the through-holes corresponding to a respective one of the apertures in position; each of the locating columns mounted through one of the apertures;
multiple conductive layers mounted on one surface of the circuit board, and the center pin of each one of the positioning connector adaptors connected to one of the conductive layers;
multiple fixing parts mounted through each of the through-holes.
